(19) United States
(12) Patent Application Publication
(10) Pub. No.: US 2012/0013568 A1
(43) Pub. Date: Jan. 19, 2012

(54) DRIVING METHOD OF TOUCH DEVICE

(76) Inventors: Yi-Ling Hung, Taoyuan County (TW); Heng-Chang Lin, Taoyuan County (TW)

(21) Appl. No.: 12/913,766

(22) Filed: Oct. 28, 2010

(30) Foreign Application Priority Data
Jul. 14, 2010 (TW) 099123146

(51) Int. Cl. G06F 3/045

(52) U.S. Cl. 345/174

(57) ABSTRACT

A resistive/capacitive integrated touch device includes a resistive touch module, a capacitive touch module and a spacer layer. The resistive touch module includes a first substrate and a first sensing layer. The capacitive touch module includes a second substrate and a second sensing layer. The second sending layer includes a plurality of first sensing pads and a plurality of second sensing pads. The spacer layer is disposed between the first and the second sensing layers. The resistive/capacitive integrated touch device utilizes the plurality of first sensing pads and the plurality of second sensing pads to detect the voltage variation of the first sensing layer for resistive sensing, and detecting the capacitance variation of the plurality of first sensing pads and the plurality of second sensing pads for capacitive sensing.

### BACKGROUND OF THE INVENTION

1. Field of the Invention

The present invention is related to a driving method of a touch device, and more particularly, to the driving method of a resistive/capacitive integrated touch device.

2. Description of the Prior Art

Touch devices such as touch screens have gained recognitions on the market due to the popularity of products like touch phones etc. Touch devices can be categorized into capacitive touch device and resistive touch device.

Resistive touch devices have high linearity, precise positioning and are suitable to use stylus as input devices. Resistive touch devices are ideal for applications such as writing and drawing. However, resistive touch devices require a relatively high pressure of touch, resulting in poor ergonomics which makes it difficult to operate by fingers, e.g. actions such as finger scrolling are limited. Capacitive touch devices can be operated by touching, or in some cases approaching, the touch panel without the need to apply excessive pressing force. However, capacitive touch devices have relatively poor linearity and less accurate positioning. The input resolution of capacitive touch devices is generally low so input apparatus such as stylus may be insensible, ruling out applications such as writing, drawing etc. Capacitive touch devices, however, are suitable for general user interfaces. In other words, resistive and capacitive touch devices have their own advantages and drawbacks.

### SUMMARY OF THE INVENTION

The present invention discloses a driving method of a touch device. The touch device comprises a resistive touch module, a spacer layer and a capacitive touch module. The resistive touch module comprises a first substrate and a first sensing layer. The first sensing layer is disposed on the first substrate. The capacitive touch module comprises a second substrate and a second sensing layer. The second sensing layer is disposed on the second substrate and comprises a plurality of first sensing pads and a plurality of second sensing pads. The spacer layer is disposed between the first sensing layer and the second sensing layer. The driving method comprises applying a voltage to the first sensing layer and utilizing the plurality of first sensing pads and the plurality of second sensing pads to detect a voltage variation of the first sensing layer; calculating position of a touch point on the touch device according to the voltage variation of the first sensing layer; coupling the first sensing layer to ground, and detecting a capacitance variation of the plurality of first sensing pad and the plurality of second sensing pads; and calculating position of the touch point on the touch device according to the capacitance variation of the plurality of first sensing pads and the plurality of second sensing pads.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating resistive/capacitive integrated touch device of the present invention.

FIG. 2 is a diagram illustrating resistive touch module of the present invention.

FIG. 3 is a diagram illustrating capacitive touch module of the present invention.

FIG. 4 is a diagram illustrating a first control circuit according to an embodiment of the present invention.

FIG. 5 is a diagram illustrating a second control circuit according to an embodiment of the present invention.

FIG. 6 is a diagram illustrating the resistive/capacitive integrated touch device proceeds scanning according to a first embodiment of the present invention.

FIG. 7 is a diagram illustrating the resistive/capacitive integrated touch device proceeds scanning according to a second embodiment of the present invention.

### DETAILED DESCRIPTION

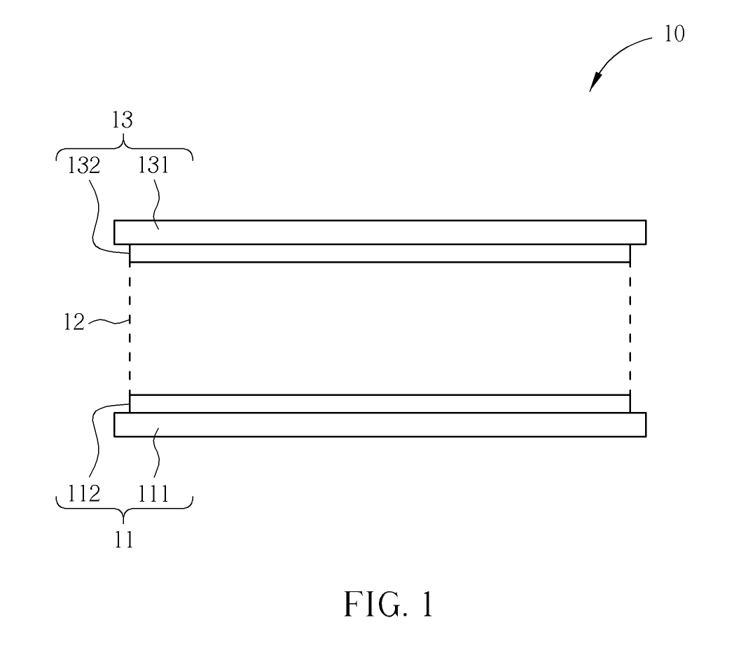

Please refer to FIG. 1. FIG. 1 is a diagram illustrating resistive/capacitive integrated touch device 10 of the present invention. Resistive/capacitive integrated touch device 10 comprises a resistive touch module 11, a spacer layer 12 and a capacitive touch module 13. Resistive touch module 11 comprises a first substrate 111 and a first sensing layer 112. First sensing layer 112 is disposed on the first substrate 111. Capacitive touch module 13 comprises a second substrate 131 and a second sensing layer 132. Second sensing layer 132 is disposed on the second substrate 131. Second sensing layer 132 comprises a plurality of first sensing pads and a plurality of second sensing pads. The first sensing layer 112 faces the second sensing layer 132. Spacer layer 12 is disposed between the first sensing layer 112 and the second sensing layer 132 for isolating the resistive touch module 11 and the capacitive touch module 13. First sensing layer 112, first sensing pads and second sensing pads are formed by a transparent conductive material. Generally, the transparent conductive materials comprise Indium Tin Oxide (ITO), Antimony Tin Oxide (ATO) or Aluminum Zinc Oxide (AZO) etc.

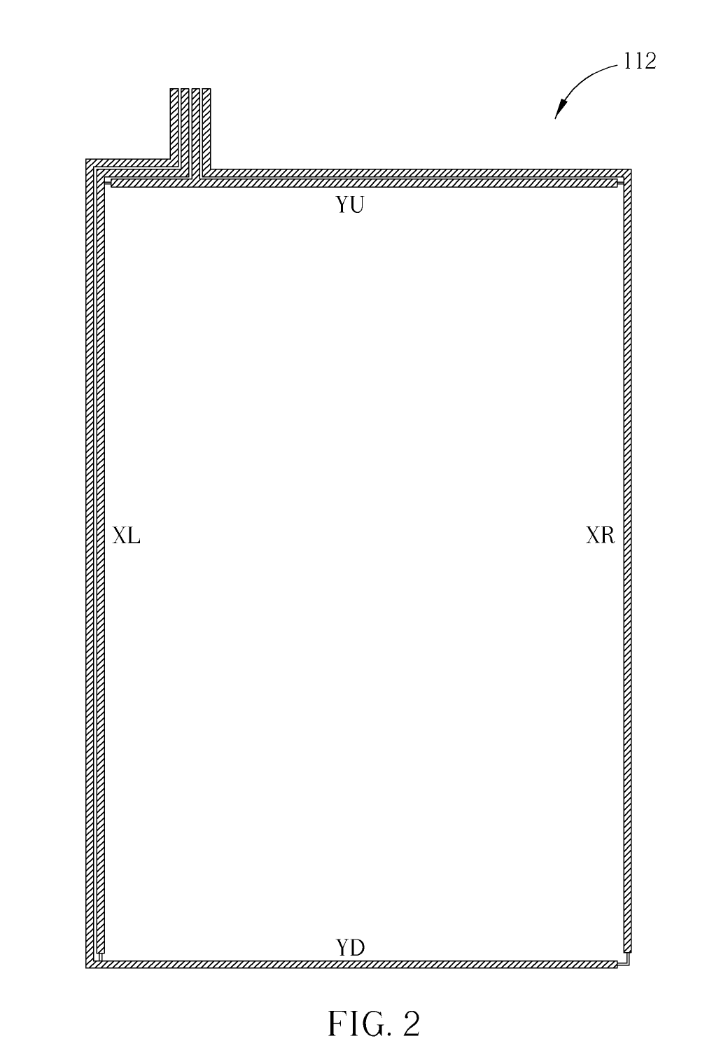

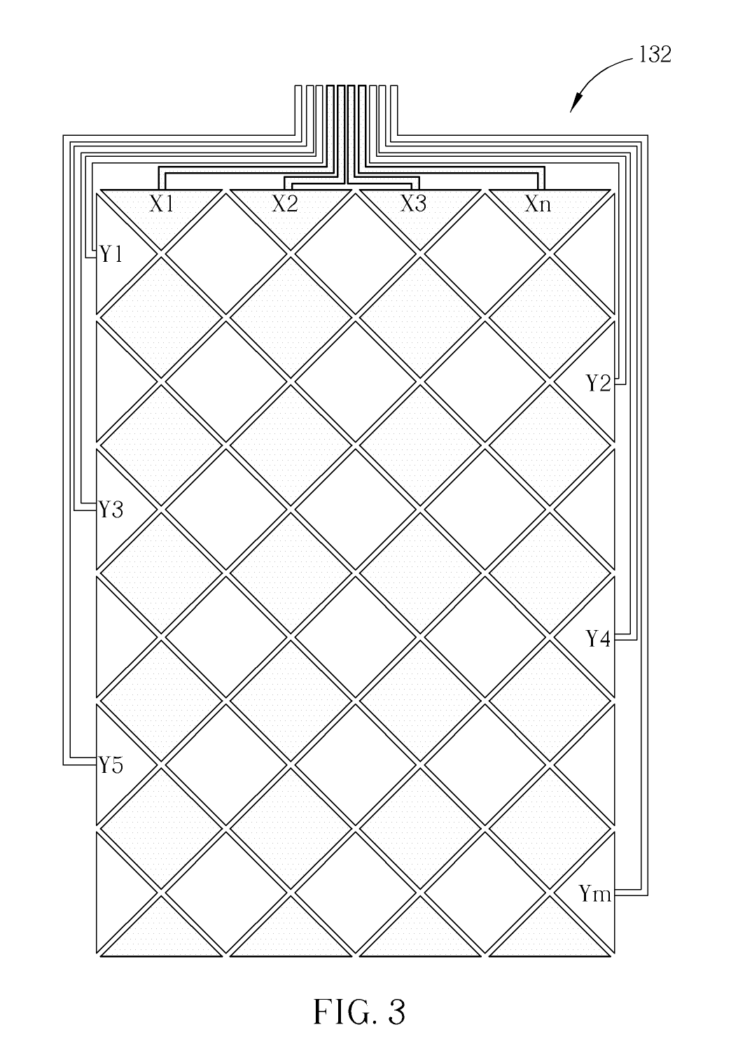

Please refer to FIG. 2. FIG. 2 is a diagram illustrating resistive touch module 11 of the present invention. The first sensing layer 112 is made entirely of a transparent conductive material. Resistive touch module 11 further comprises four input/output ends XL, XR, YU, YD, disposed at the left, right, upper and lower sides of the first sensing layer 112 respectively. Please refer to FIG. 3. FIG. 3 is a diagram illustrating capacitive touch module 13 of the present invention. The second sensing layer 132 comprises n first sensing pads X1˜Xn and m second sensing pads Y1˜Ym, wherein n and m are positive integers. First sensing pads X1˜Xn and second sensing pads Y1˜Ym can be disposed/arranged according to different patterns to form the second sensing layer 132. For instance, in the present embodiment, the first sensing pads X1˜Xn are arranged horizontally and the second sensing pads Y1˜Ym are arranged vertically, such that the first sensing pads X1˜Xn are disposed perpendicular to the second sensing pads Y1˜Ym, so first sensing pads X1˜Xn and second sensing pads Y1˜Ym interlace to form the second sensing layer 132. Each sensing pad of first sensing pads X1˜Xn and second sensing pads Y1˜Ym comprises an input/output end.

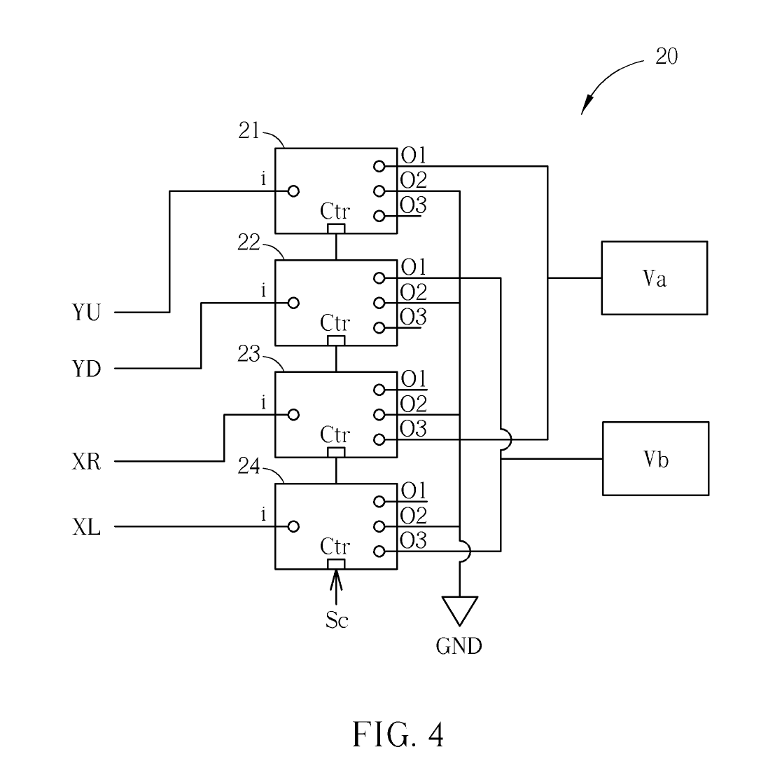

Please refer to FIG. 4. FIG. 4 is a diagram illustrating a first control circuit 20 according to an embodiment of the present invention. The first control circuit 20 controls the voltage of input/output ends XL, XR, YU and YD of resistive touch module 11. The first control circuit 20 comprises a first, second, third and fourth selection circuit 21, 22, 23 and 24. Each of the first˜fourth selection circuits 21˜24 comprises an input end i, a first output end O1, a second output end O2, a third output end O3 and a control end Ctr. The output end i of the first selection circuit 21 is coupled to the input/output end YU, the first output end O1 of the first selection circuit 21 is coupled to a first voltage source Va, the second output end O2 of the first selection circuit 21 is coupled to a ground end GND and the third output end O3 of the first selection circuit 21 is floating. The input end i of the second selection circuit 22 is couple to the input/output end YD, the first output end O1 of the second selection circuit 22 is coupled to a second voltage source Vb, the second output end O2 of the second selection circuit 22 is coupled to the ground end GND and the third output end O3 of the second selection circuit 22 is floating. The input end i of the third selection circuit 23 is coupled to the input/output end XR, the first output end O1 of the third selection circuit 23 is floating, the second output end O2 of the third selection circuit 23 is couple to the ground end GND, and the third output end O3 of the third selection circuit 23 is couple to the first voltage source Va. The input end i of the fourth selection circuit 24 is coupled to the input/output end XL, the first output end O1 of the fourth selection circuit 24 is floating, the second output end O2 of the fourth selection circuit 24 is coupled to the ground end GND, and the third output end O3 of the fourth selection circuit 24 is coupled to the second voltage source Vb. The first voltage source Va and the second voltage source Vb provide predetermine voltage levels. In the present embodiments, the first voltage source Va provides voltage of a high voltage level and the second voltage source Vb provides voltage of a low voltage level. The control ends Ctr of the first˜fourth selection circuits 21˜24 receive a control signal Sc.

The number of bits of the control signal Sc is according to an exponent number of the total number of input/output ends of the resistive touch module 11 expressed in binary. For instance, when the resistive touch module 11 comprises 4 input/output ends (e.g. 4=2̂2), the control signal Sc is 2 bits; when the resistive touch module 11 comprises 8 input/output ends (e.g. 8=2̂3), the control signal Sc is 3 bits. In the present embodiment, resistive touch module 11 comprises 4 input/output ends YU, YD, XL and XR, hence the control signal Sc is 2 bits. When the control signal Sc is “00”, each of the first˜fourth selection circuits 21˜24 couples the input end i to the first output end O1, so the input/output end YU is coupled to the first voltage source Va, the input/output end YD is coupled to the second voltage source Vb and the input/output ends XR and XL are floating. In other words, voltage drop between the input/output ends YU and YD causes the current to flow from input/output end YU to input/output end YD. When the control signal Sc is “01”, each of the first˜fourth selection circuits 21˜24 couples the input end to the third output end O3, so the input/output end XR is coupled to the first voltage source Va, the input/output end XL is coupled to the second voltage source Vb and the input/output ends YU and YD are floating. In other words, voltage drop between the input/output ends XR and XL causes the current to flow from input/output end XR to input/output end XL. When the control signal Sc is “1×” (e.g. when control signal Sc is “10” or “11”), each of the first˜fourth selection circuits 21˜24 couples the input end i to the second output end O2 so the input/output ends YU, YD, XL and XR are all coupled the ground end GND.

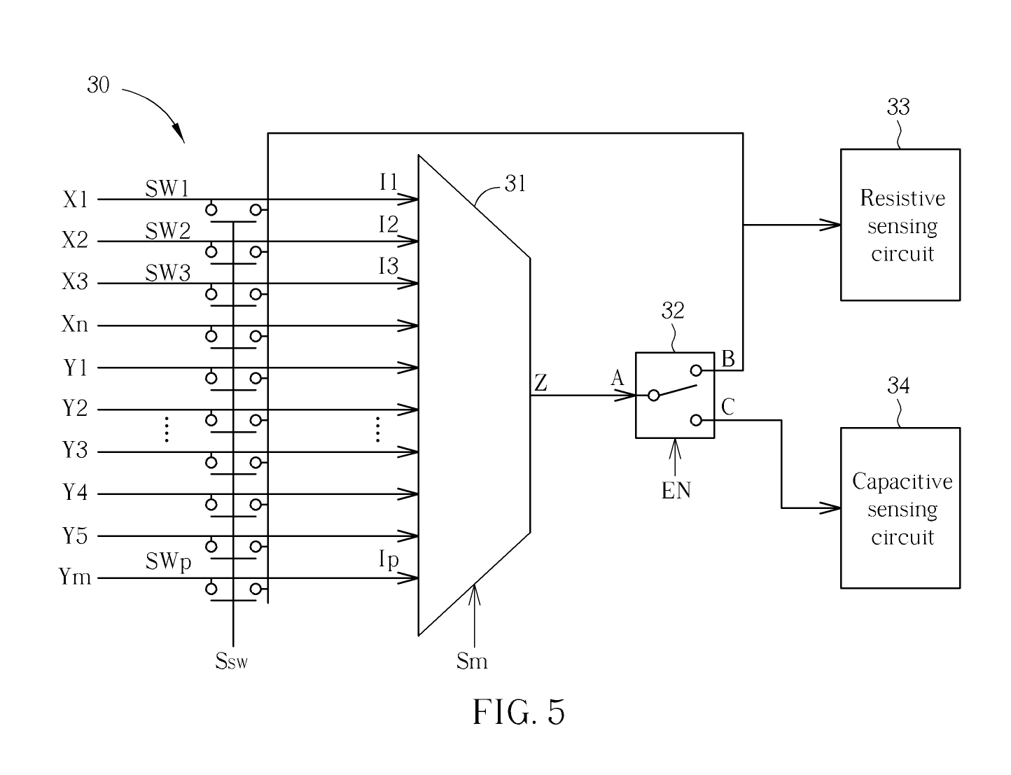

Please refer to FIG. 5. FIG. 5 is a diagram illustrating a second control circuit 30 according to an embodiment of the present invention. The second control circuit 30 detects signals of the touch point on the resistive/capacitive integrated touch device 10. The second control circuit 30 comprises p switches SW1˜SWp, a main selection circuit 31, an enabling circuit 32, a resistive sensing circuit 33 and a capacitive sensing circuit 34. The parameter p is a positive integer and corresponds to a total number of the first sensing pads X1˜Xn and the second sensing pads Y1˜Ym (e.g. p=n+m). Each of the input ends I1˜Ip of main selection circuit 31 is coupled to a sensing pad (e.g. one of the first sensing pads X1˜Xn or one of the sensing pads Y1˜Ym) of the capacitive touch module 13. The main selection circuit 31 couples one of input ends I1˜Ip to the output end Z according to a main selection control signal Sm. The number of bits of the main selection control signal Sm is according to an exponent number of the total number of input ends I1˜Ip expressed in binary. In the present embodiment, the main selection control signal Sm is 4 bits. An input end A of the enabling circuit 32 is coupled to the output end Z of the main selection circuit 31. A first output end B of the enabling circuit 32 is coupled to the resistive sensing circuit 33, and a second output end C of the enabling circuit 32 is coupled to the capacitive sensing circuit 34. Enabling circuit 32 operates according to an enabling signal EN. In the present embodiment, when the enabling signal EN is “1” (e.g. a high voltage level), the enabling circuit 32 couples the input end A to the first output end B, and when the enabling signal EN is “0” (e.g. a low voltage level), the enabling circuit 32 couples the input end A to the second output end C. A first end of each of the switches SW1˜SWp is coupled between the sensing pads (e.g. one of first sensing pads X1˜Xn or second sensing pads Y1˜Ym) and the corresponding input ends I1˜Ip of the main selection circuit 31. A second end of each of the switches SW1˜SWp is coupled to the resistive sensing circuit 33 and the first output end B of the enabling circuit 32. The switches SW1˜SWp are controlled according to a switch control signal Ssw. In the present embodiment, when the switch control signal Ssw is “1”, the switches SW1˜SWp are turned on (e.g. short circuit) to couple first sensing pads X1˜Xn and second sensing pads Y1˜Ym to the capacitive sensing circuit 33. When the switch control signal Ssw is “0”, the switches SW1˜SWp are turned off (e.g. open circuit) to couple first sensing pads X1˜Xn and second sensing pads Y1˜Ym to the corresponding input ends I1˜Ip of the main selection circuit 31.

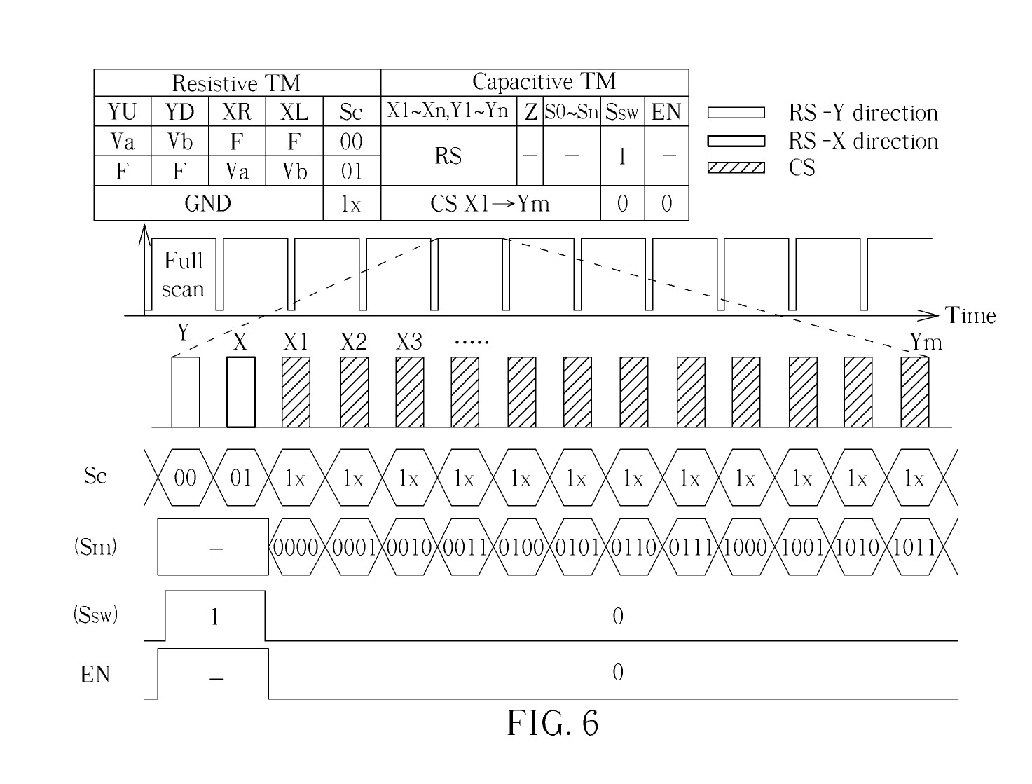

Please refer to FIG. 6. FIG. 6 is a diagram illustrating the resistive/capacitive integrated touch device 10 proceeds scanning according to a first embodiment of the present invention. In the present invention, resistive sensing (short for RS as shown in diagrams) is prioritized, meaning the resistive/capacitive integrated touch device 10 provides voltage to the resistive touch module (Resistive TM) 11 first. The resistive/capacitive integrated touch device 10 outputs control signal Sc of “00”, subsequently input/output ends XR and XL are floating (short for F as shown in diagrams), input/output end YU is coupled to the first voltage source Va while input/output end YD is coupled to the second voltage source Vb so as to generate a voltage drop for first sensing layer 112 to output current in the Y direction (e.g. vertical direction) It is noted that in the present embodiment the first voltage source Va is a high voltage level and the second voltage source Vb is a low voltage level, the current flows from input/output end YU to the input/output end YD. The resistive/capacitive integrated touch device 10 then outputs control signal Sc of “01”, so input/output ends YU and YD are floating, input/output end XR is coupled to the first voltage source Va while input/output end XL is coupled to the second voltage source Vb to generate a voltage drop for the first sensing layer 112 to output current in the X direction (e.g. horizontal direction). Since the first voltage source Va is a high voltage level and the second voltage source Vb is a low voltage level in the present embodiment, the current flows from input/output end XR to the input/output end XL. When resistive touch module 11 proceeds sensing, the resistive/capacitive integrated touch device 10 outputs the switch control signal Ssw of “1” for all first sensing pads X1˜Xn and second sensing pads Y1˜Ym of the capacitive touch module (Capacitive TM) 13 to couple to the resistive sensing circuit 33.

This way, when the first sensing layer 112 outputs current in the X or Y direction, the resistive/capacitive integrated touch device 10 utilizes the first sensing pads X1˜Xn and the second sensing pads Y1˜Ym to detect the voltage variation of the first sensing layer 112. For instance, when an external force is applied to the first substrate 111 or the second substrate 131 for the first sensing layer 112 to contact the second sensing layer 132 while the first sensing layer 112 outputs current in the Y direction, since all sensing pads of the capacitive touch module 13 are coupled to the resistive sensing circuit 33 (e.g. when switch control signal Ssw is “1”, switches SW1˜SW are turned on), so by utilizing capacitive touch module 13 to detect the voltage variation (e.g. the signal of the touch point) in the Y direction of the first sensing layer 112, resistive sensing circuit 33 can calculate the position of the touch point in the Y direction on the first sensing layer 112. Similarly, when the first sensing layer 112 outputs current in the X direction, by utilizing capacitive touch module 13 to detect the voltage variation in the X direction of the first sensing layer 112, resistive sensing circuit 33 can calculate the position of the touch point in the X direction on the first sensing layer 112.

If resistive sensing described above is able to detect the signal of the touch point, resistive/capacitive integrated touch device 10 skips capacitive sensing (short for CS as shown in diagrams). If resistive sensing is unable to detect the signal of the touch point, resistive/capacitive integrated touch device 10 proceeds capacitive sensing, in which resistive/capacitive integrated touch device 10 utilizes only the capacitive touch module 13.

As shown by FIG. 6, when resistive/capacitive integrated touch device 10 proceeds capacitive sensing, the control signal Sc is “1×”, the switch control signal Ssw is “0” and the enabling signal EN is “0”. When the control signal Sc is “1×”, the input/output ends YU, YD, XR and XL are coupled to the ground end GND (e.g. the resistive touch module 11 is turned off) and the resistive touch module 11 acts as a shielding layer for the capacitive touch module 13. When the switch control signal Ssw is “0”, switches SW1˜SWp are turned off for first sensing pads X1˜Xn and second sensing pads Y1˜Ym of the capacitive touch module 13 to couple to the corresponding input ends I1˜Ip of the main selection circuit (MSC) 31. When the enabling signal EN is “0”, the enabling circuit 32 couples the output end Z of the main selection circuit 31 to the capacitive sensing circuit 34. The main selection control signal Sm sequentially switches to “0000”, “0001”, “0010” . . . to sequentially output signals of the first sensing pads X1˜Xn and second sensing pads Y1˜Ym to the capacitive sensing circuit 34 via the enabling circuit 32, such that during capacitive sensing the capacitive sensing circuit 34 sequentially detects the capacitance variation on the first sensing pads X1˜Xn and second sensing pads Y1˜Ym. For instance, when an object touches or approaches the first substrate 111 or the second substrate 131, the capacitance of the first sensing pads and the second sensing pads corresponding to the touch point is varied, the capacitive sensing circuit can then calculate the X-axis coordinate data and Y-axis coordinate data of the touch point on the resistive/capacitive integrated touch device 10 according to the capacitance variation.

Simply put, for every complete scan, resistive/capacitive integrated touch device 10 proceeds resistive sensing first; the resistive sensing circuit 33 detects the voltage variation in the Y direction and X direction on the first sensing layer 112 via the second sensing layer 132, if the signal of the touch point is not detected, resistive/capacitive integrated touch device 10 then proceeds with capacitive sensing; capacitive sensing circuit 34 sequentially detects the capacitance variation of the first sensing pads X1˜Xn and second sensing pads Y1˜Ym, e.g. in the order of X1, X2, X3 . . . Xn, Y1, Y2, Y3 . . . Ym.

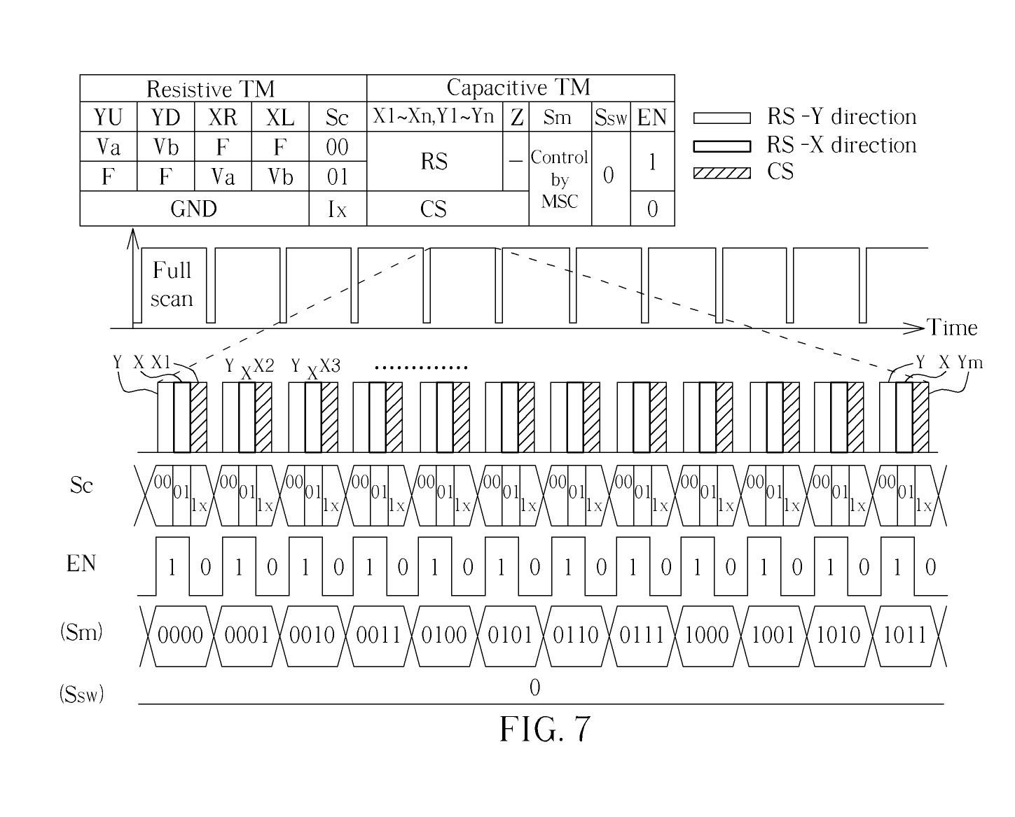

Please refer to FIG. 7. FIG. 7 is a diagram illustrating the resistive/capacitive integrated touch device 10 proceeds scanning according to a second embodiment of the present invention. The second embodiment of resistive/capacitive integrated touch device 10 scanning is similar to that of the first embodiment in FIG. 6. The difference is that in the first embodiment, resistive sensing is to detect the voltage variation in Y direction and X direction on the first sensing layer 112 via the first sensing pads X1˜Xn and second sensing pads Y1˜Ym of the second sensing layer 132, but in the second embodiment, resistive sensing utilizes the first sensing pads X1 Xn and second sensing pads Y1˜Ym sequentially to detect the corresponding positions on the first sensing layer 112. In other words, in the second embodiment, the switch control signal Ssw is “0” regardless of resistive sensing or capacitive sensing, meaning the switches SW1˜SWp remain turned off and the first sensing pads X1˜Xn and second sensing pads Y1˜Ym are coupled to the corresponding input ends I1˜Ip of the main selection circuit 31.

As shown in FIG. 7, the control signal Sc is sequentially switched to “00” and “01”, so the first sensing layer 112 outputs current in Y direction and X direction respectively; at the same time the enabling signal EN is “1” and the switch control signal Ssw is “0”, meaning the main selection circuit 31 couples the first sensing pad X1 to the enabling circuit 32, and the enabling circuit 32 then couples the first sensing pad X1 to the resistive sensing circuit 33. Therefore, the resistive sensing circuit 33 detects, via the first sensing pad X1, a voltage at a position corresponding to the first sensing pad X1 in the Y direction on the first sensing layer 112, then the resistive sensing circuit 33 detects, via the first sensing pad X1, a voltage at a position corresponding to the first sensing pad X1 in the X direction on the first sensing layer 112. Then the enabling signal is switched to “0”, control signal Sc is “1×” and the switch control signal Ssw remains to be “0” for turning off the resistive touch module 11 and the enabling circuit 32 is coupled to the capacitive sensing circuit 34 (e.g. in this case, the first sensing pad X1 is coupled to the capacitive sensing circuit 34) so as to utilize the capacitive sensing circuit 34 to detect the capacitance variation of the first sensing pad X1. This way, resistive sensing and capacitive sensing using the first sensing pad X1 is completed. The main selection control signal Sm then switches to “0001”, such the main selection circuit 31 couples the first sensing pad X2 to the enabling circuit 32, then using first sensing pad X2 to repeat the steps above, so as to use first sensing pad X2 to complete the resistive sensing and capacitive sensing. By switching the main selection control signal Sm, the above steps are repeated for all of the first sensing pads X1˜Xn and the second sensing pads Y1˜Ym, so as to complete the resistive sensing and capacitive sensing of resistive/capacitive integrated touch device 10.

In other words, when applying a voltage to the first sensing layer 112 (e.g. when the resistive/capacitive integrated touch device 10 is being touched), the resistive/capacitive integrated touch device 10 utilizes the first sensing pads X1˜Xn and the second sensing pads Y1˜Ym of the second sensing layer 132 to detect the voltage variation of the first sensing layer 112. The resistive/capacitive integrated touch device 10 calculates the position of the touch point according to the voltage variation of the first sensing layer 112. If the signal of the touch point is not detected from detecting the voltage variation of the first sensing layer 112, the resistive/capacitive integrated touch device 10 couples the first sensing layer 112 to the ground, and then detects the capacitance variation of the first sensing pads X1˜Xn and the second sensing pads Y1˜Ym; the position of the touch point can then be calculated accordingly. As shown in FIG. 6, when applying a voltage to the first sensing layer 112, the resistive/capacitive integrated touch device 10 can utilize all of the first sensing pads X1˜Xn and the second sensing pads Y1˜Ym of the second sensing layer 132 at once to detect the voltage variation of the first sensing layer 112. As shown in FIG. 7, the resistive/capacitive integrated touch device 10 can also sequentially utilize one sensing pad out of the first sensing pads X1˜Xn and the second sensing pads Y1˜Ym at a time to detect the voltage variation of the first sensing layer 112.

In conclusion, the resistive/capacitive integrated touch device of the present invention comprises a resistive touch module, a capacitive touch module and a spacer layer. The resistive touch module comprises a first substrate and a first sensing layer. The capacitive touch module comprises a second substrate and a second sensing layer. The second sensing layer comprises a plurality of first sensing pads and a plurality of second sensing pads. The spacer layer is disposed between the first sensing layer and the second sensing layer. The resistive/capacitive integrated touch device can utilize the plurality of first sensing pads and the plurality of second sensing pads to detect the voltage variation of the first sensing layer for resistive sensing, and then detect the capacitance variation of the first sensing pads and the second sensing pads for capacitive sensing. Therefore, the resistive/capacitive integrated touch device of the present invention combines functions of the resistive and capacitive touch devices into one single touch panel, and incorporates the advantages of the resistive and capacitive touch devices.

Those skilled in the art will readily observe that numerous modifications and alterations of the device and method may be made while retaining the teachings of the invention.

What is claimed is:

1. A driving method of a touch device, the touch device comprising a resistive touch module, a spacer layer and a capacitive touch module, the resistive touch module comprising a first substrate and a first sensing layer, the first sensing layer disposed on the first substrate, the capacitive touch module comprising a second substrate and a second sensing layer, the second sensing layer disposed on the second substrate and comprising a plurality of first sensing pads and a plurality of second sensing pads, the spacer layer disposed between the first sensing layer and the second sensing layer, the driving method comprising:
applying a voltage to the first sensing layer and utilizing the plurality of first sensing pads and the plurality of second sensing pads to detect a voltage variation of the first sensing layer;
calculating position of a touch point on the touch device according to the voltage variation of the first sensing layer;
coupling the first sensing layer to ground, and detecting a capacitance variation of the plurality of first sensing pads and the plurality of second sensing pads; and
calculating position of the touch point on the touch device according to the capacitance variation of the plurality of first sensing pads and the plurality of second sensing pads.

2. The driving method of claim 1, wherein applying the voltage to the first sensing layer and utilizing the plurality of first sensing pads and the plurality of second sensing pads to detect the voltage variation of the first sensing layer is applying the voltage to the first sensing layer and utilizing all of the plurality of first sensing pads and the plurality of second sensing pads to detect the voltage variation of the first sensing layer.

3. The driving method of claim 1, wherein applying the voltage to the first sensing layer and utilizing the plurality of first sensing pads and the plurality of second sensing pads to detect the voltage variation of the first sensing layer is utilizing a first sensing pad of the plurality of first sensing pads and a second sensing pad of the plurality of second sensing pads sequentially to detect the voltage variation of the first sensing layer.

4. The driving method of claim 1, wherein coupling the first sensing layer to ground causes the resistive touch module to be a shielding layer for the capacitive touch module.

5. The driving method of claim 1, wherein coupling the first sensing layer to ground, and detecting the capacitance variation of the plurality of first sensing pads and the plurality of second sensing pads, when the plurality of first sensing pads and the plurality of second sensing pads non detect the voltage variation of the first sensing layer.
